(19) United States
(12) Patent Application Publication
(10) Pub. No.: US 2004/0064838 A1
(43) Pub. Date: Apr. 1, 2004

(54) Method and device for viewing a live performance

(76) Inventors: Lykke Olesen, Djurhamn (SE); Kaj Mickos, Nacka (SE)

Correspondence Address: Rolf Fasth, Fasth Law Offices, 629 E Boca Raton Road, Phoenix, AZ, 85022, US

(21) Appl. No.: 10/250,539

(22) PCT Filed: Jan. 8, 2002
(86) PCT No.: PCT/US02/04552

(51) Int. Cl. H04N 7/173; H04N 7/18

(52) U.S. Cl. 725/105; 348/143

(57) ABSTRACT

The method is for remotely viewing a performance in real time by providing a first remote viewer, a first camera monitoring a first object to produce a first image and a second camera monitoring a digital pixel area larger than a second moving object disposed within the digital pixel area to produce a second moving image in real time. The first image is updated every first time period and sent the web site. The second image is continuously updated every second time period and sent to the web site. The second time period is shorter than the first time period. The web site superimposes the second image over the first image so that both the second and first images are viewable to the first remote viewer via the network.

### TECHNICAL FIELD

The present invention relates to a method and device for viewing a live performance via the Internet.

### BACKGROUND AND SUMMARY OF THE INVENTION

The availability of high quality performances such as live music, theater, opera, art exhibitions, sport events, etc., are of concentrated in metropolitan areas such as large cities. One drawback of live performances that are broadcast using conventional technology is that the audience must be physically present and therefore must travel to the location of the live performance. This may be very time consuming and expensive so many pass on the opportunities to enjoy the live performances. Live performances are often made available only in metropolitan areas where a lot of people live so make sure the performance is available to a sufficiently large number of people to increase revenues. In the alternative, the remote viewer may view recorded performances on video tapes or live performances on television. It is not the same feeling to view performances recorded on a videotape or live on television compared to actually be at the location where the live performance is performed.

Another drawback of live performances is that the size of the audiences is sometimes limited by the facilities where the live performance takes place. Very specialized performances are sometimes subsidized by governments because the events are considered beneficial to the society but do not generate sufficient funds, such as operas, despite full occupancy of the facilities. Sometimes it may be desirable to perform in relatively small concert halls, despite a very high interest and demand, to maintain a good atmosphere in the hall with a small but enthusiastic audience.

Conventional real time web-cast performances provide poor quality of both sound and images due to lack of broadband width and insufficient capacities of the computer equipment and the network systems that are available today. Web-cast performances are therefore very slow to use and unclear to watch.

There is a need for a system that would enable remote viewers to enjoy the life performances performed in areas other than the area of the viewers. There is need for a system that inexpensively and realistically provides the remote viewer with a real time experience that is very similar to the experience of the viewers who are present at the site of the live performance.

The present invention provides such a system. More particularly, the invention relates to a method for remotely viewing a performance in real time by providing a first remote viewer, a first camera monitoring a first object to produce a first image and a second camera monitoring a digital pixel area larger than a second moving object disposed within the digital pixel area to produce a second moving image in real time. The first and second cameras are connected to the web site used by the remote viewer. The first image is updated every first time period and sent the web site. The second image is continuously updated every second time period and sent to the web site. The second time period is shorter than the first time period. The web site superimposes the second image over the first image so that both the second and first images are viewable to the first remote viewer via the network.

### BRIEF DESCRIPTION OF THE DRAWING

FIG. 1 is a schematic flow diagram of method and device of the present invention.

### DETAILED DESCRIPTION

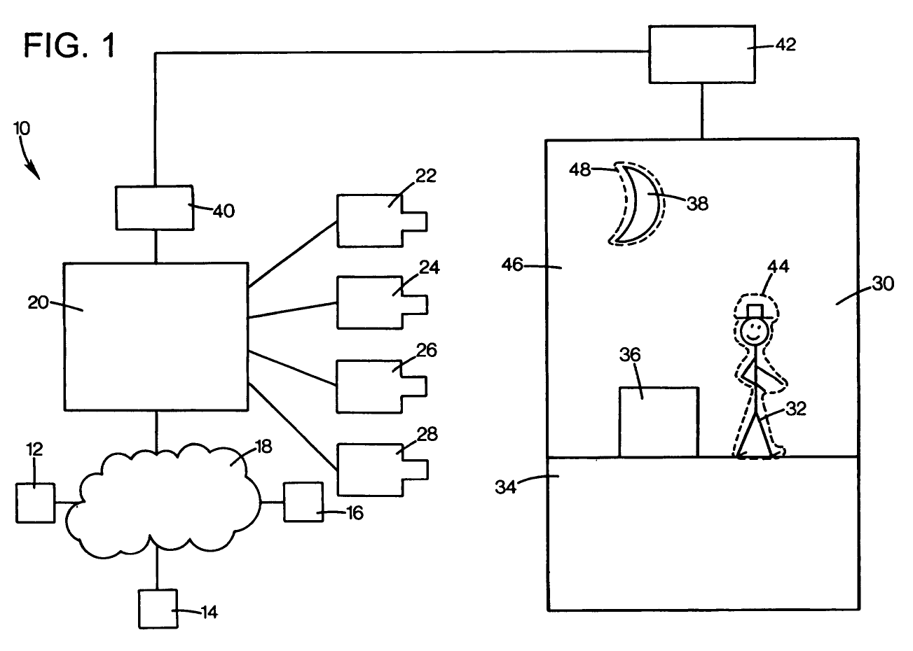

With reference to FIG. 1, the present invention is a sophisticated viewing and listening system 10 for viewing and listening to a live performance via the Internet. It is to be understood that the present invention is not limited to live performance but may be used in any application for receiving and delivering services in real time via the Internet that may be monitored with digital cameras. The services may include, but are not limited to, music, theater, art exhibitions, sports events, political debates, etc.

An important feature of the present invention is that it is possible to view a performance in real time with a high quality picture while minimizing the bandwidth usage. More particularly, a set of viewers 12, 14, 16 may be separately connected via the Internet 18 to a web site 20. The web site 20 may advertize the upcoming events and encourage viewers to buy access to the viewing of the upcoming live performances. The site 20 may also have menu lists of the available performances so that the viewers can select the live performance of his/her choice.

Preferably, the web site 20 is connected to a set of digital and programmable cameras 22, 24, 26 and 28. Each camera may have or be associated with a distinct IP address. As is described in detail below, the cameras may be set up to monitor activities such as activities that may occur in a display area or scene 30. For example, the scene 30 may include a living person 32 on a stage 34 with a bench 36 and a moon 38 in a background 46 thereof. Of course, the scene may include any items and the above scene 30 is only used as an example to illustrate the principles of the present invention.

As indicated above, each camera may have a separate identifier and provide different services. For example, the camera 22 may be designed and programmed to provide moving pictures of a selected portion of the scene 30. More particularly, the camera 22 may be programmed to only show movements, in real time, of the person 32 as defined by digital pixels disposed inside a certain area 44 that is identical to or slightly larger than the display area of the person 32. The camera 22 may be very similar to a conventional TV camera apart from only showing the certain changes of movements in real time of the selected pixels within the area 44. In this way, the camera 22 does not show anything outside the area 44 and may be designed to compress the signals and only send changes of the pixels inside the area 44 back to the web site 20. By only transmitting the changes of the image recorded by the camera 22, the amount of bandwidth required is substantially reduced. If showing the entire scene 30 in real time requires 5 MHz of bandwidth, the limitation of only transmitting the pixels that have changed in the image recorded by the camera 22 may reduce the bandwidth requirement to about 500 kbit or less. In this way, a conventional modem may be used to receive the transmission of the signals without sacrificing the quality of the image.

As described below, the rest of the image displayed on the viewer's monitor remains the same until the background image is updated. To complement the camera 22, the camera 24 may be programmed to show all items in a background area 46 including the bench 36 and the stage 34 or any other low priority components of the scene 30. The camera 24 may be programmed to only update its view every other minute so that the picture remains frozen between the updates. Similarly, the camera 26 may be programmed to show pictures of the audience or any other view with only infrequent updates. The camera 28 may be programmed to show a medium priority item such as the moon 38, as limited by the pixels in an area 48, that is slowly moving across the background 46. The updating of the picture of the moon 38 may be updated more frequently than the images shown by the cameras 24, 26 so that the slow movement of the moon 38 may be viewed by the viewers.

The cameras may either be fixed or movable. Preferably, the cameras are not designed to be movable by the viewers to prevent conflict when more than one viewer has access to the same camera. Of course, it may be possible for a viewer to buy not only access to the camera but also the exclusive ability to move and operate the camera such as zooming and changing the position of the camera views.

The web site 20 may be monitored and controlled by an administrative unit, such as a web master or web site management 40, that in turn is connected to an administrative unit, such as a management team 42 that monitors and runs the theater which has the scene 30. The management 40 may update the information on the web site 20 such as the live performances available and the price for the various performances and services. The management 40 may also exclude certain undesirable viewers and users of the web site 20. A portion of the revenue received from the viewers by the management 40 is shared with the management team 42 of the theater and the performers so that it is in the interest of the theater management and the performers to participate in the service provided by the management 40 of the web site 20. The performers may also enhance the publicity of the performers by the transmission of the performance on the Internet. The management 40 may also provide the team 42 with technical expertise and service related to the set up of the cameras and sound systems at the site of the performance.

In operation, the viewer 12, for example, may select the live performance of the scene 30 by scrolling down a menu list on the site 20. The viewer 12 may pay via a credit card or any other pre-payment scheme. The viewer may also be a member of a club associated with the web site 20 so that no pre-payment is necessary but the viewer may be asked to provide a password or code. The viewer will then be asked to select the desired live performance from a menu. There may also be several submenus that more specifically provides the viewer with options. For example, the viewer 12 may be asked to select which cameras he/she would like to have access to. The service provider may charge a higher rate for the real time camera 22 compared to the other cameras 24, 26, 28 because the camera 22 takes up more space and resources on the bandwidth. In this way, the viewer 12 decides how much money he/she would like to spend on viewing the performance.

Before the viewer 12 make the final decision, the viewer 12 may pre-view the live performance for a short period of time. After the viewer 12 has selected the live performance and the type of services desired including the number of cameras, the viewer 12 pays and can then view the performance on the computer monitor or any other display unit at the location of the viewer 12. The price of the live performance may be different depending upon which performance is selected. Because the viewer 12 does not see the entire scene 30 in real time a substantial saving or reduction of the required bandwidth may be achieved.

If the viewer 12 selected and paid for all the cameras, the viewer 12 will see all the movements of the person 32 in real time while the stage 34, the bench 36 and the background 46 are only occasionally updated and the movement of the moon 38 is updated more frequently without being in continuously updated as in real time. In this way, the moving images in real time transmitted by the camera 22 are super-imposed over the more static images transmitted by the cameras 24, 26, 28. This means that the limited bandwidth resources are not unnecessarily used for showing portions of the scene 30 in real time that are less important and do not move. For example, it is often not important to the viewer whether he/she sees the stage 34 or the bench 36 in real time since they are not likely to change much during the performance.

Similarly, the viewers 14, 16, 18 may simultaneously view the scene with the same or different numbers of cameras as selected by the viewer 12. In this way, each viewer may customize the service to his/her own individual needs. The number of people that may view the play or opera taking place on the scene 30 is virtually unlimited. Also, the geographical location of the viewer is if no importance as long as the viewer has access to the web site 20. It may be possible to provide the viewers with access to a plurality of real time cameras so that the viewer may select which real time camera the viewer would like to have access to at a certain time. The viewer may then switch to another real time camera, as desired during the performance. For example, in a marathon race, a first viewer may be interested in viewing the leading group while a second viewer may be more interested in viewing a racer in the back of the main group.

In this way, the first viewer may activate the real time cameras that follow the leading group while the second viewer may decide to activate the real time cameras that follow a different group behind the leading group. As described above, the background images remain static and are only updated occasionally while the runners themselves are shown in real time. The web site 20 may be programmed so that the viewer may save money by viewing a static picture while the runners are in areas not covered by the real time cameras and the viewer may be alerted when the runners are in view by the real time cameras so that the real time cameras are only activated by the viewer when the runners are in view of the real time cameras.

The revenue received from the viewers 12, 14, 16, 18 by the management 40 or any other entity associated with the web site 20 are then shared with the promotor or management of the performance performed on the scene.

It is also possible to provide head mounted virtual reality (VR) eye wear to the subscriber/viewer who is located in a location that is different from the location of the live performance. For example, the viewer may select a virtual seat in the performance hall by selecting to have access to a certain camera positioned in or adjacent to the selected seat. When looking through the VR eye wear, the eye wear may be programmed so that the viewer will only see a portion of the stage so that viewer must turn his/her head to see the whole stage. Similarly, when viewing a tennis match the viewer must turn his/her head to see the entire court. This gives a more realistic feeling of actually being in the performance hall. The eye wear may also be programmed, as described above, so that certain objects on the stage are shown in real time while less important items are not shown in real time and are only occasionally updated.

To save bandwidth, the eye wear may be programmed so that when the viewer looks at, for example, one tennis player only the camera programmed to show that player in real time is activated and when the viewer turns his/her head towards the second tennis player a second real time camera is activated. Because the background is static, the viewer may not notice when the activation from the first camera is switched to the second camera. In other words, the turning of the head of the viewer may be a commando to switch cameras.

With reference to the situation described in FIG. 1, it may also be possible for the viewer to select a seat in the performance hall from which the viewer may see more than one item/person in real time by paying a higher fee since more bandwidth is required. By utilizing the VR eye wear or a conventional computer monitor, an unlimited number of people may select the same virtual seat. In this way, a high number of viewers may have access to the best seat in the performance hall.

It may also be possible for the viewer to change the seat during the performance, as desired. For example, if the seat selected initially is too far back, the viewer may, for a change fee, change to another virtual seat that is closer to the stage. The VR eye wear may be used to move the vision sideways and also the distance to the stage may be adjusted to meet the specific needs of the viewer. If the viewer is using a monitor, the monitor may be equipped with virtual zooming features on the screen so that the viewer may select the most desirable distance to the stage. The monitor screen may also be equipped with a display that shows how much money has been spent on viewing the performance. To save money, the viewer may stop the activation of the real time cameras during the performance and switch the entire viewing area to be shown statically in non-real time. For example, the viewer may freeze a beautiful view and concentrate on the sound instead. The monitor may also show where in the performance hall the viewer is virtually located.

The invention may also permit additional interaction by the viewer. For example, if the viewer is watching a horse race, the viewer may bet on horses by using a credit card. The horses will be shown in real time while the track is not shown in real time. The viewer may also select which camera the viewer would like to use. For example, in a long 50 kilometers ski race, the viewer may follow certain skiers as the skiers pass 20 km, 30 km control points, etc., so that the viewers may selectively activate the stationary cameras at the control points at different times depending which ski racer the viewer would like to watch. In this way, the ski racers are shown in real time while the background is static. As described above, the background may be updated occasionally.

While the present invention has been described in accordance with preferred compositions and embodiments, it is to be understood that certain substitutions and alterations may be made thereto without departing from the spirit and scope of the following claims.

We claim:

1. A method for remotely viewing a performance in real time, comprising:
providing a first remote viewer, connected to a web site via a network, a first camera monitoring a first object to produce a first image, a second camera monitoring a digital pixel area larger than a second moving object disposed within the digital pixel area to produce a second moving image in real time, the first and second cameras being connected to the web site;
updating the first image every first time period and sending the first image to the web site;
continuously updating the second image every second time period and sending the second image to the web site, the second time period being shorter than the first time period; and
the web site superimposing the second image over the first image so that both the second and first images are viewable to the first remote viewer via the network.

2. The method according to claim 1 wherein the method further comprises providing a second remote viewer and a third camera producing a third image, the third image is superimposed over the first image so that both the third and first images are viewable to the second remote viewer at the same time the second and first images are viewable to the first remote viewer.

3. The method according to claim 1 wherein the method further comprises the first remote viewer paying a fee for viewing the first and second images.

4. The method according to claim 1 wherein the method further comprises the first remote viewer paying a first fee for viewing the first image and a second fee for viewing the second image, the second fee being higher than the first fee.

5. The method according to claim 1 wherein the method further comprises providing the first remote viewer with a pre-view prior to charging the first remote viewer.

6. The method according to claim 1 wherein the method further comprises the first remote viewer selects a number of cameras prior to being charged.

7. The method according to claim 1 wherein the method further comprises mounting a virtual reality eye wear on the first remote viewer, the eye wear being connected to the web site.

8. The method according to claim 7 wherein the method further comprises adjusting a virtual position of the first remote viewer relative to the first and second images.

9. The method according to claim 8 wherein the method further comprises charging the first remote viewer based on the virtual position.

10. The method according to claim 7 wherein the method further comprises programming the eye wear to show the second image in real time and the first image in a pre-recorded version.
